(19) United States
(12) Patent Application Publication
(10) Pub. No.: US 2005/0186987 A1
(43) Pub. Date: Aug. 25, 2005

(54) Portable communication device

(76) Inventor: Ren-Hao Liu, Taipei City, TW (US)

Correspondence Address: J C PATENTS, INC., 4 VENTURE, SUITE 250, IRVINE, CA, 92618, US

(21) Appl. No.: 10/788,185

(22) Filed: Feb. 25, 2004

(51) Int. Cl. H04M 1/66; H04M 1/68

(52) U.S. Cl. 455/556.1; 455/550.1

(57) ABSTRACT

A portable communication device comprising a casing, a host module, a wireless phonetic communication module, a phonetic input unit, a phonetic output unit, an image-display unit and a directive input unit is provided. The host module and the wireless phonetic communication module are installed inside the casing. The wireless phonetic communication module is electrically coupled to the host module. The phonetic input unit, the phonetic output unit and the image-display unit are also installed inside the casing and are electrically coupled to the host module. The directive input unit is a detachable unit mounted on the casing. The directive input unit is electrically coupled to the host module through wireless transmission so that the host module can be remotely operated.

### BACKGROUND OF THE INVENTION

1. Field of the Invention

The present invention relates to a portable communication device. More particularly, the present invention relates to a portable communication device with wireless remote control function.

2. Description of the Related Art

In the information age, electronic communication has become an indispensable part of our daily life. Messages are shuttled from people to people through all kinds of portable communication devices. Portable communication devices such as mobile phone have wireless communication capability. In general, a mobile phone comprises a casing, a host module and a man-machine interface. The host module is housed inside the casing and the man-machine interface (MMI) is set up on the casing and electrically connected to the host module. The man-machine interface includes, for example, a keyboard, a microphone, a speaker or a flat-panel display.

To stimulate the desire for purchasing a particular mobile phone, manufacturers often provide additional functions and streamline the mobile phone. At present, most mobile phones are no longer a device designed simply for phonetic communication but a multi-functional recreational module. For example, most mobile phone in the market has networking function so that games can be downloaded to play. Alternatively, a miniature digital camera may be installed so that the mobile phone can be used to take pictures.

When the mobile phone with a miniature digital camera is used to take a picture, the user must press a button on the phone to trigger the digital camera. Because the button must be reached by the picture taker, the digital camera on the mobile phone can at most capture the image of a portion of the user (for example, the upper half of a user). If the photographer needs to take a head-to-toe image of oneself or oneself with other people, an assistant is required. Furthermore, if the arm muscle of the user is tense when the button is pressed, the digital cameral on the light mobile phone may vibrate leading to the capturing of a blurry image.

In addition, the user has to press a button on the mobile phone when a phone call arrives and the user has to press a button on the mobile phone when a number needs to be dialed. Similarly, to play games, a user needs to access the buttons on the mobile phone. In other words, all the built-in functions including games, digital camera and phonetic communication must be accessed through the buttons on keyboard of the mobile phone. Thus, the conventional mobile phone lacks operational flexibility.

### SUMMARY OF THE INVENTION

Accordingly, at least one objective of the present invention is to provide a portable communication device with a casing having a detachable directive input unit capable of controlling the built-in functions of the portable communication device through a wireless remote connection.

To achieve these and other advantages and in accordance with the purpose of the invention, as embodied and broadly described herein, the invention provides a portable communication device. The portable communication device comprises a casing, a host module, a wireless phonetic communication module, a phonetic input unit, a phonetic output unit, an image-display unit and a directive input unit. The host module and the wireless phonetic communication module are installed inside the casing. The wireless phonetic communication module is electrically coupled to the host module. The phonetic input unit, the phonetic output unit and the image-display unit are also installed inside the casing and are electrically coupled to the host module. The directive input unit is a detachable unit mounted on the casing. The directive input unit is electrically coupled to the host module through wireless transmission so that the host module can be remotely operated.

According to the preferred embodiment of the present invention, the host module further comprises a first wireless transmission interface and the directive input unit further comprises a second wireless transmission interface. The second wireless transmission interface is electrically coupled to the first wireless transmission interface through a wireless transmission medium. Furthermore, the second wireless transmission interface transmits a command signal to the first wireless transmission interface through the wireless transmission medium.

According to the preferred embodiment of the present invention, the wireless transmission medium is radio wave or infrared ray.

According to the preferred embodiment of the present invention, the directive input unit is a keyboard with a numeric keys and special function keys.

According to the preferred embodiment of the present invention, the portable communication device further comprises an image-capturing unit set up on the casing and electrically connected to the host module for capturing an optical image.

According to the preferred embodiment of the present invention, the image-capturing unit is a detachable unit mounted on the casing.

Accordingly, through a remove wireless connection, the directive input unit of the portable communication device can be detached from the casing to control the portable communication device using the keyboard on the directive input unit. In other words, the directive input unit can be detached from the casing of the mobile phone and taken away to a remote location so that games, the camera and mobile phone can be activated by hand through the directive input unit. Consequently, the flexibility of using the portable communication device is significantly enhanced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of an assembled portable communication device according to one preferred embodiment of the present invention.

FIG. 1B is a perspective view of a disassembled portable communication device according to the preferred embodiment of the present invention.

FIG. 2 is a block diagram showing the electrical connection between the host module and other units of the portable communication device according to the preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

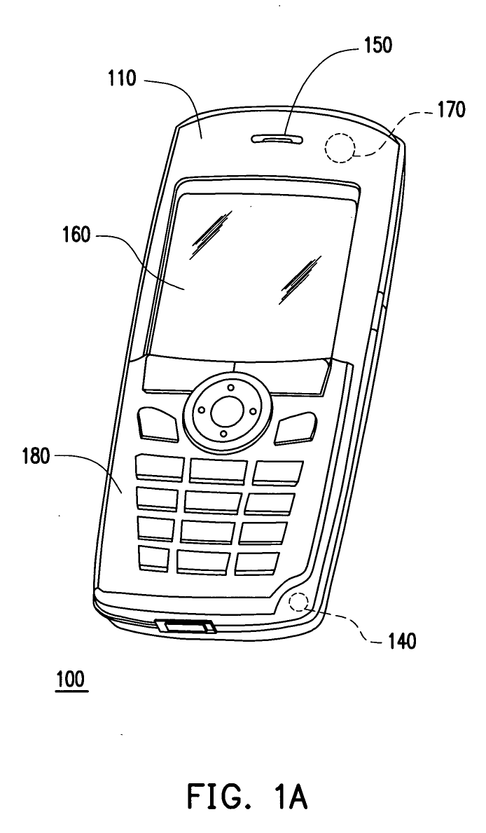

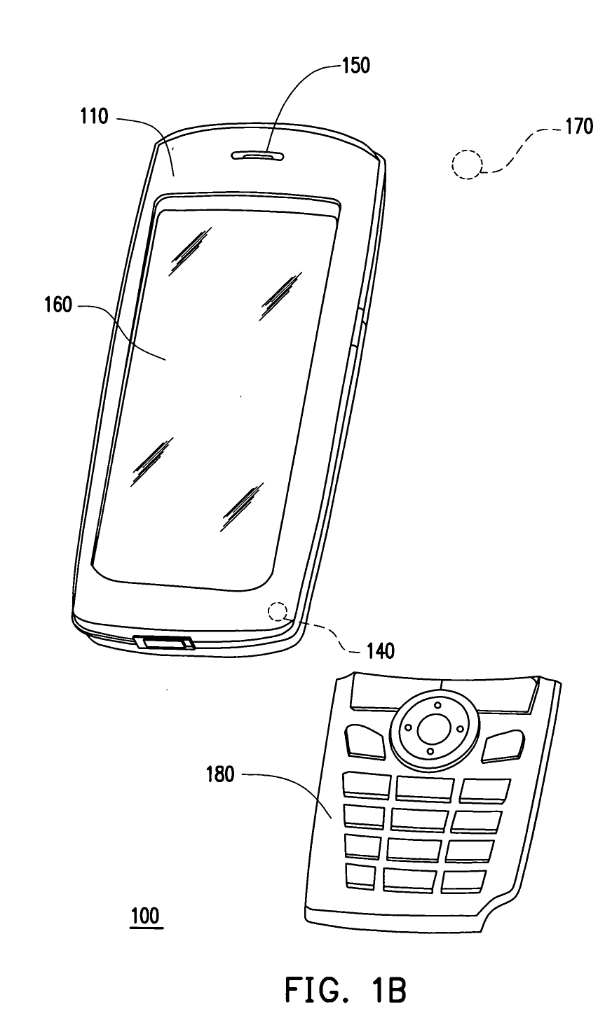

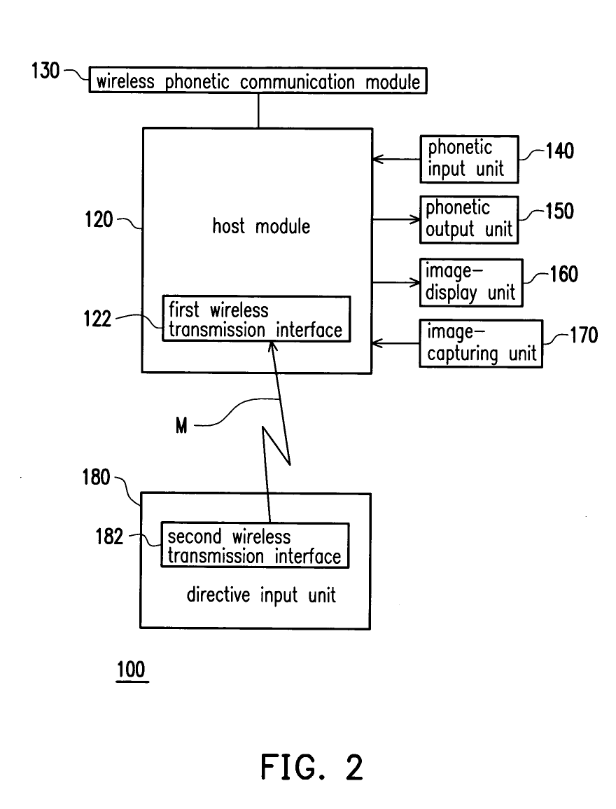

FIG. 1A is a perspective view of an assembled portable communication device according to one preferred embodiment of the present invention. FIG. 2 is a block diagram showing the electrical connection between the host module and other units of the portable communication device according to the preferred embodiment of the present invention. As shown in FIGS. 1A and 2, the portable communication device 100 is a mobile phone, for example. The portable communication device 100 comprises a casing 110, a host module 120, a wireless phonetic communication module 130, a phonetic input unit 140, a phonetic output unit 150, an image-display unit 160, an image-capturing unit 170 and a directive input unit 180. The host module 120 further comprises components including a microprocessor, a memory unit and a power supply (not shown), for example. The host module 120 and the wireless phonetic communication module 130 are installed inside the casing 110. The wireless phonetic communication module 130 is electrically coupled to the host module 120 for receiving/transmitting phonetic communication signals. The phonetic input unit 140, the phonetic output unit 150, the image-display unit 160, the image-capturing unit 170 and the directive input unit 180 are set up on the casing 110 and electrically connected to the host module 120. The wireless phonetic communication module 130 provides the wireless phonetic communication function for the portable communication device 100. The phonetic input unit 140 is, for example, a microphone for receiving phonetic messages and the phonetic output unit 150 is, for example, a speaker for emitting phonetic messages. The image-display unit 160 is a flat-panel display and the image-capturing unit 170 is a digital camera, for example. Furthermore, the directive input unit 180 is, for example, a keyboard for controlling the host module 120. The keyboard has a plurality of numeric keys and special function keys and the keys are either press buttons or touch control pads.

As shown in FIG. 2, the host module 120 of the portable communication device 100 further comprises a first wireless transmission interface 122 and the directive input unit 180 of the portable communication device 100 further comprises a second wireless transmission interface 182. The second wireless transmission interface 182 is electrically coupled to the first wireless transmission interface 122 through a wireless transmission medium M such as radio wave or infrared ray. Hence, the directive input unit 180 is electrically coupled to the host module 120 through wireless transmission. Since any command signal keyed into the directive input unit 180 can be transmitted from the second wireless transmission interface 182 to the first wireless transmission interface 122 via the wireless transmission medium M, the host module 120 can be remotely controlled by the directive input unit 180.

FIG. 1B is a perspective view of a disassembled portable communication device according to the preferred embodiment of the present invention. As shown in FIG. 1B, the image-capturing unit 170 and the directive input unit 180 can be detached from the casing 110 of the portable communication device 100. A user holding the directive input unit 180 may initiate any built-in function of the portable communication device 100 such as taking pictures using the image-capturing unit 170, playing games on the image-display unit 160, communicating with a third party and so on at a remote location.

In summary, the directive input unit of the portable communication device can be detached from the casing to control the portable communication device at a remote location using the keyboard on the directive input unit. In other words, the directive input unit can be used at a remote location to initiate various built-in functions such as games and built-in units such as the digital camera and cellular phone on the portable communication device. Consequently, the flexibility of using the portable communication device is significantly enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A portable communication device, comprising:
a casing;
a host module set up inside the casing;
a wireless phonetic communication module set up inside the casing and electrically connected to the host module for receiving/transmitting phonetic communication signals;
a phonetic input unit set up on the casing and electrically connected to the host module for receiving a phonetic message;
a phonetic output unit set up on the casing and electrically connected to the host module for outputting a phonetic message;
an image-display unit set up on the casing and electrically connected to the host module for capturing optical images; and
a detachable directive input unit mounted on the casing and electrically connected to the host module via wireless transmission so that the host module can be controlled through the directive input unit at a remote location.

2. The portable communication device of claim 1, wherein the host module further comprises a first wireless transmission interface and the directive input unit further comprises a second wireless transmission interface such that the second wireless transmission interface is electrically coupled to the first wireless transmission interface through a wireless transmission medium so that a command signal can be transmitted from the second wireless transmission interface to the first wireless transmission interface.

3. The portable communication device of claim 2, wherein the wireless transmission medium comprises radio wave or an infrared ray.

4. The portable communication device of claim 1, wherein the directive input unit comprises a keyboard.

5. The portable communication device of claim 1, wherein the device further comprises an image-capturing unit set up on the casing and electrically connected to the host module for capturing optical images.

6. The portable communication device of claim 5, wherein the image-capturing unit is a detachable unit connected to the casing.
